(19) United States
(12) Patent Application Publication
(10) Pub. No.: US 2026/0233794 A1
(43) Pub. Date: Aug. 13, 2026

(54) MOBILE BODY

(71) Applicant: Sony Group Corporation, Tokyo (JP)

(72) Inventor: Kazuo HONGO, Tokyo (JP)

(73) Assignee: Sony Group Corporation, Tokyo (JP)

(21) Appl. No.: 19/155,975

(22) PCT Filed: Jan. 31, 2024
(86) PCT No.: PCT/JP2024/003015

§ 371 Date: Aug. 13, 2025

(30) Foreign Application Priority Data
Mar. 23, 2023 (JP) 2023-047183

(51) Int. Cl. B62D 57/028; B60B 19/00

(52) U.S. Cl. CPC B62D 57/028; B60B 19/003

(57) ABSTRACT

To reduce the number of motors mounted on a mobile body that can realize both wheel traveling and leg walking.

A mobile body including: a main body part; at least one or more drive wheels attached to the main body part and rotated by driving of a motor; a leg part provided correspondingly to the drive wheels and moving forward and backward in accordance with rotation of the drive wheels; and a leg part drive unit that controls driving of the leg part in an up-down direction.

### TECHNICAL FIELD

The present disclosure relates to a mobile body.

### BACKGROUND ART

In recent years, a legged mobile body that can freely walk and move on an uneven surface such as stairs or an unpaved road by a plurality of leg parts has been developed. The legged mobile body can select a point where the leg is to be grounded in a distributed manner, and thus, can smoothly move on an uneven ground where there is a ground crack, a step, or the like.

On the other hand, there is also a wheeled mobile body that can perform wheel traveling by a plurality of wheels driven by a motor or the like. The wheeled mobile body can travel at high speed on a flat leveled ground with a relatively simple mechanism.

Therefore, a mobile body that exhibits high moving ability in both the uneven ground and the leveled ground by using a leg mechanism and a wheel mechanism in combination has been studied (see Patent Document 1 below).

### CITATION LIST

### Patent Document

Patent Document 1: Japanese Patent Application Laid-Open No. 2006-315587

### SUMMARY OF THE INVENTION

### Problems to Be Solved by the Invention

In the mobile body disclosed in Patent Document 1 described above, an actuator that drives the wheel mechanism and an actuator that drives the leg mechanism are separately provided. Therefore, in the mobile body disclosed in Patent Document 1, the number of mounted actuators increases, and the manufacturing cost, weight, power consumption, and the like of the mobile body increase.

Therefore, it has been required to reduce the number of motors mounted on a mobile body that can realize both the wheel traveling and the leg walking.

### Solutions to Problems

According to the present disclosure, there is provided a mobile body including: a main body part; at least one or more drive wheels attached to the main body part and rotated by driving of a motor; a leg part provided correspondingly to the drive wheels and moving forward and backward in accordance with rotation of the drive wheels; and a leg part drive unit that controls driving of the leg part in an up-down direction.

### BRIEF DESCRIPTION OF DRAWINGS

FIG. 1 is a side view schematically illustrating a mobile body according to a first structure.

FIG. 2 is a side view illustrating a state at the time of leg walking of the mobile body illustrated in FIG. 1.

FIG. 3 is a side view schematically illustrating a mobile body according to a second structure.

FIG. 4 is a schematic plan view illustrating a detailed structure of the mobile body illustrated in FIG. 3.

FIG. 5 is a side view schematically illustrating a mobile body according to a third structure.

FIG. 6 is a schematic plan view illustrating a detailed structure of the mobile body illustrated in FIG. 5.

FIG. 7 is a schematic plan view illustrating a modification in which an attachment angle between a drive wheel and a leg part is adjusted by using a universal joint.

FIG. 8 is a schematic plan view illustrating a modification in which an attachment angle between a drive wheel and a leg part is adjusted by using a ball joint.

FIG. 9 is a side view schematically illustrating a structure of a mobile body according to a first modification.

FIG. 10 is a side view schematically illustrating a structure of a mobile body according to a second modification.

FIG. 11 is a side view schematically illustrating a structure of a mobile body according to a third modification.

FIG. 12 is a side view schematically illustrating a structure of a mobile body according to a fourth modification.

FIG. 13 is a side view schematically illustrating a structure of a mobile body according to a fifth modification.

FIG. 14 is a side view schematically illustrating a structure of a mobile body according to a sixth modification.

FIG. 15 is a side view schematically illustrating a structure of a mobile body according to a seventh modification.

FIG. 16 is a side view schematically illustrating a structure of a mobile body according to an eighth modification.

FIG. 17 is a side view schematically illustrating a structure of a mobile body including four drive wheels of mecanum wheels and leg parts in only two front wheels.

FIG. 18 is a side view schematically illustrating a structure of a mobile body including four drive wheels of omni wheels and leg parts in only two front wheels.

### MODES FOR CARRYING OUT THE INVENTION

A preferred embodiment of the present disclosure will be described below in detail, with reference to the accompanying drawings. Note that, in the present description and drawings, components having substantially the same functional configuration are denoted by the same reference signs, and redundant description is omitted.

Note that the description will be given in the following order.
1. Structure of mobile body
1.1. First structure
1.2. Second structure
1.3. Third structure
2. Modifications
2.1. First modification
2.2. Second modification
2.3. Third modification
2.4. Fourth modification
2.5. Fifth modification
2.6. Sixth modification
2.7. Seventh modification
2.8. Eighth modification
3. Supplementary note

### 1. Structure of Mobile Body

### 1.1. First Structure

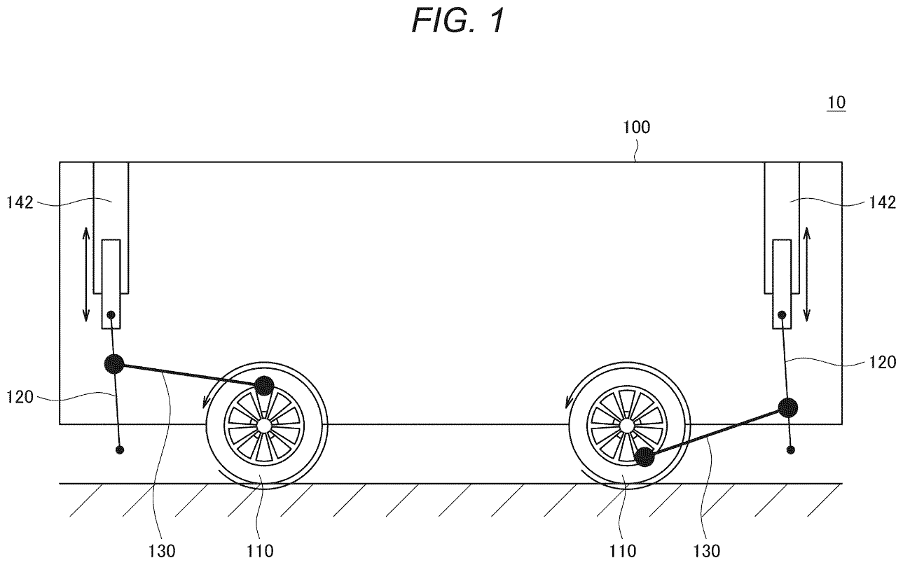

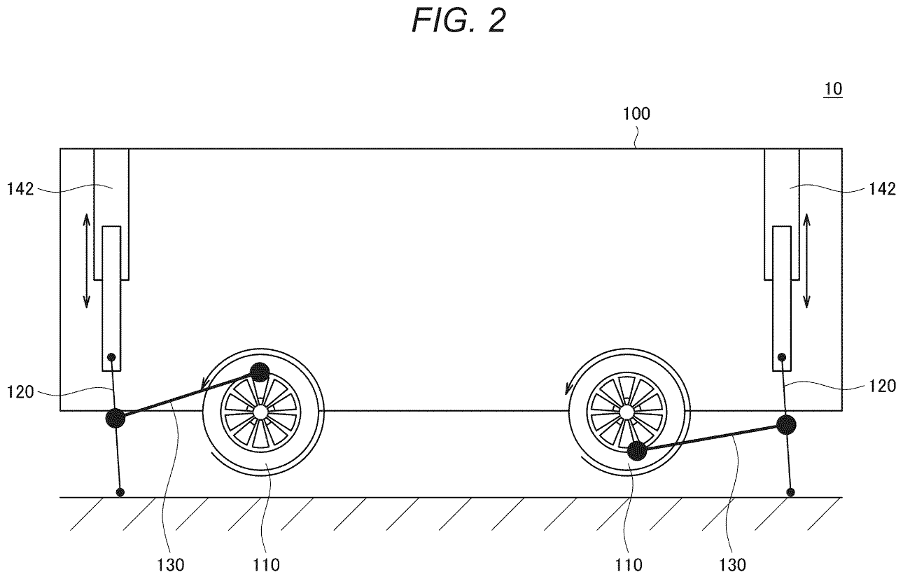

First, a first structure of a mobile body according to one embodiment of the present disclosure will be described with reference to FIGS. 1 to 2. FIG. 1 is a side view schematically illustrating a mobile body 10 according to the first structure. FIG. 2 is a side view illustrating a state at the time of leg walking of the mobile body 10 illustrated in FIG. 1.

As illustrated in FIG. 1, the mobile body 10 according to the first structure includes one main body part 100 and a total of four drive wheels 110 provided at two positions in the front-rear direction of the mobile body 10, two wheels being provided in each position from the front to the back of the paper surface of FIG. 1. Each of the four drive wheels 110 is provided with a leg part 120, a leg part drive unit 142, and a transmission mechanism 130.

Hereinafter, an example in which the mobile body 10 includes four drive wheels 110 will be mainly described. However, the mobile body 10 may include two drive wheels 110, six drive wheels 110, or eight drive wheels 110.

The main body part 100 has a housing of a rectangular parallelepiped shape and corresponds to a body part of the mobile body 10. In the main body part 100, each of the four transmission mechanisms 130, each of the four leg parts 120, and each of the four leg part drive units 142 are provided correspondingly to each of the four drive wheels 110. Furthermore, although not illustrated, a control device that controls the overall motion of the mobile body 10 and a power supply device that supplies power to each part of the mobile body 10 are further provided in the main body part 100.

The drive wheel 110 is a wheel that is rotated by a not-illustrated motor about a rotation shaft extending in a direction perpendicular to the paper surface of FIG. 1. The drive wheel 110 may be a general wheel including a wheel and a tire. The drive wheels 110 are provided, for example, at positions where a rectangle is formed at the time when the main body part 100 is viewed from above. The four drive wheels 110 can be rotated independently of each other by a not-illustrated motor.

The leg part 120 includes a rigid longitudinal structural member, and is provided closer to an end side of the mobile body 10 than the drive wheel 110 (that is, the outer side in the front-rear direction) in the traveling direction of the mobile body 10. The leg part 120 may include a rod-shaped or rectangular parallelepiped structural member, or may be formed by combining a plurality of structural members. The leg part 120 is linearly moved in the up-down direction by the leg part drive unit 142, and is swung in the front-rear direction by the transmission mechanism 130 along with the rotation of the drive wheel 110. The mobile body 10 can perform leg walking by performing a linear motion in the up-down direction and a swing motion in the front-rear direction in each of the leg parts 120.

The transmission mechanism 130 is a driving force transmission mechanism that converts the rotational motion of the drive wheel 110 into a reciprocating motion and transmits the reciprocating motion to the leg part 120. Specifically, the transmission mechanism 130 is a link that connects any one point in the radial direction of the drive wheel 110 (a point other than the center of the wheel) and one point of the leg part 120. With this link, in the transmission mechanism 130, because one end of the link connected to the drive wheel 110 rotates along with the rotation of the drive wheel 110, one end of the link connected to the leg part 120 can be made to perform reciprocating motion. Therefore, the transmission mechanism 130 can swing the leg part 120 back and forth while the drive wheel 110 makes one rotation.

The leg part drive unit 142 is a drive mechanism that is provided above the leg part 120 and linearly moves the leg part 120 in the up-down direction. The leg part drive unit 142 may be, for example, a trapezoidal screw, a ball screw, a shaft motor, an ultrasonic actuator, a pneumatic cylinder, a water pressure cylinder, or an oil pressure cylinder. With this configuration, because the leg part drive unit 142 can perform the linear motion more smoothly and with high rigidity, the leg part 120 can be smoothly and linearly moved. Note that, in a case where the leg part drive unit 142 is a ball screw, the leg part drive unit 142 can control the ease of back drive by using the length of the lead of the ball screw, and thus, characteristics corresponding to the application can be easily realized.

According to the configuration described above, as illustrated in FIG. 1, the mobile body 10 can create a state in which the leg part 120 is not grounded and the drive wheel 110 is grounded by pulling up the leg part 120 in the upward direction by the leg part drive unit 142. By rotating the drive wheels 110 in such a state, the mobile body 10 can perform the wheel traveling by the drive wheels 110. The leg part 120 lifted by the leg part drive unit 142 in the upward direction may be fixed, for example, by an electromagnetic brake to leg part drive unit 142.

Furthermore, as illustrated in FIG. 2, the mobile body 10 can create a state in which the drive wheel 110 is not grounded and the leg part 120 is grounded by pulling up the leg part 120 by the leg part drive unit 142. By rotating the drive wheel 110 in such a state and linearly moving the leg part 120 in the up-down direction by the leg part drive unit 142, the mobile body 10 can perform the leg walking by the leg parts 120.

The mobile body 10 according to the present embodiment can drive the leg part 120 in the up-down direction, which requires high torque to support the mass of the main body part 100, by using the dedicated leg part drive unit 142, and meanwhile, can drive the leg part 120 in the front-rear direction, which does not require high torque, by using the rotation of the drive wheel 110. Therefore, because the mobile body 10 can drive a part of the leg part 120 by using the rotation of the drive wheel 110, the number of motors to be mounted can be reduced.

Furthermore, in the mobile body 10, the leg part 120 and the drive wheel 110 can be constituted independently of each other. That is, in the mobile body 10, the length of the leg part 120 and the diameter of the drive wheel 110 can be designed independently of each other. Therefore, the mobile body 10 can further lengthen the leg part 120 in order to further enhance the climbing ability on steps or the like at the time of leg walking, and at the same time, can further reduce the diameter of the drive wheel 110 in order to reduce the torque required for the rotation of the drive wheel 110.

### 1.2. Second Structure

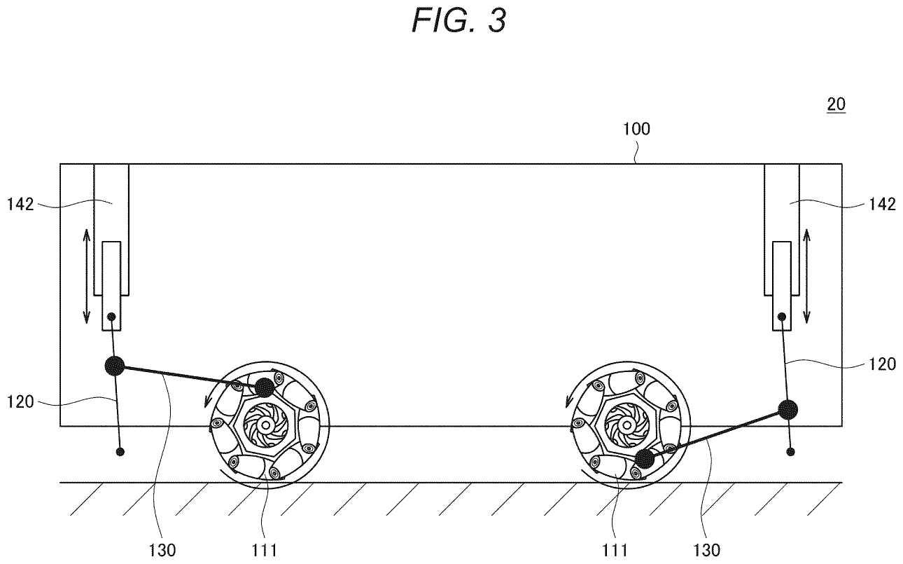

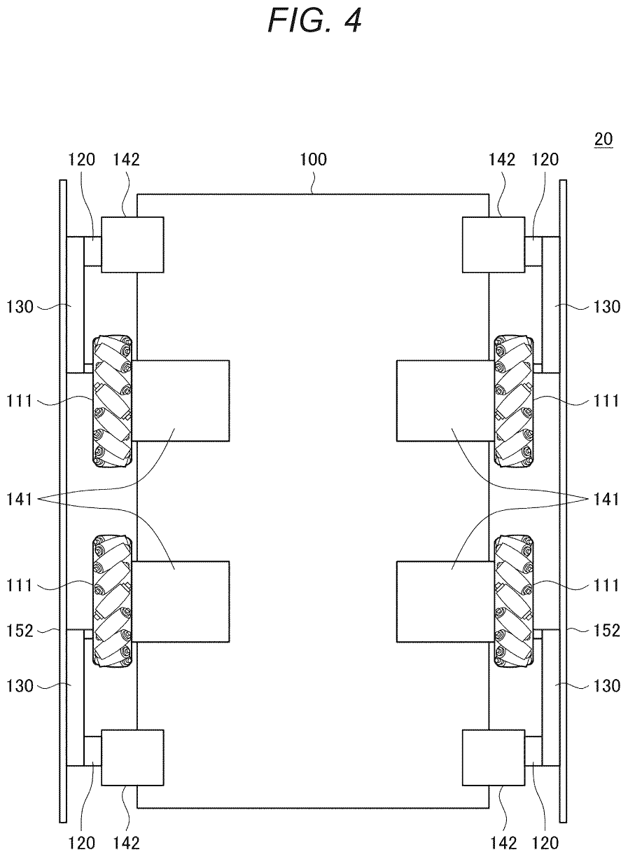

Next, the second structure of the mobile body according to the present embodiment will be described with reference to FIGS. 3 and 4. FIG. 3 is a side view schematically illustrating a mobile body 20 according to the second structure. FIG. 4 is a schematic plan view illustrating a detailed structure of the mobile body 20 illustrated in FIG. 3.

As illustrated in FIG. 3, the mobile body 20 according to the second structure is different from the mobile body 10 according to the first structure in that a drive wheel 111 is a mecanum wheel. The mecanum wheel is a wheel that enables omnidirectional translation and configured by attaching a plurality of barrel-shaped rollers extending in an oblique direction with respect to the circumferential direction of the wheel side by side on the traveling surface in the circumferential direction. By controlling the rotation speed and the rotation direction of each of the drive wheels 111 that are mecanum wheels, the mobile body 20 can omnidirectionally translate and turn on the spot at the time of wheel traveling.

More specifically, as illustrated in FIG. 4, the mobile body 20 includes one main body part 100 and four drive wheels 111. Each of the four drive wheels 111 is provided with the leg part 120, a motor 141, the leg part drive unit 142, and the transmission mechanism 130. Moreover, the mobile body 20 is provided with exterior parts 152 on both sides in the left-right direction of the main body part 100.

The drive wheel 111 is a mecanum wheel as described above, and is attached to the main body part 100 in parallel with the traveling direction of the mobile body 20. The leg part 120 is a longitudinal structural member, and is provided closer to an end side than the drive wheel 111 (that is, the outer side) in the traveling direction of the mobile body 20. The leg part 120 moves up and down in a direction perpendicular to the paper surface of FIG. 4 by the leg part drive unit 142, and swings with the rotational motion of the drive wheel 111.

The motor 141 is provided inside the housing of the main body part 100 correspondingly to the drive wheel 111, and rotates the drive wheel 111. The transmission mechanism 130 is a link that connects the drive wheel 110 to the leg part 120, and transmits the rotational motion of the drive wheel 111 into a reciprocating motion and transmits the reciprocating motion to the leg part 120. For example, the transmission mechanism 130 is a link that connects any one point in the radial direction of the drive wheel 110 and one point of the leg part 120.

The exterior part 152 is provided further on the outer side of the transmission mechanism 130 so as to cover the entire side surface of the mobile body 20. The exterior part 152 can protect the transmission mechanism 130, the drive wheel 111, and the leg part 120 from the external environment.

Because the mobile body 20 according to the second structure is a mecanum wheel in which the drive wheel 111 is movable omnidirectionally, the mobile body can omnidirectionally translate at the time of wheel traveling. Furthermore, the mobile body 20 according to the second structure can perform leg walking by the leg parts 120 by grounding the leg parts 120 without grounding the drive wheels 111.

### 1.3. Third Structure

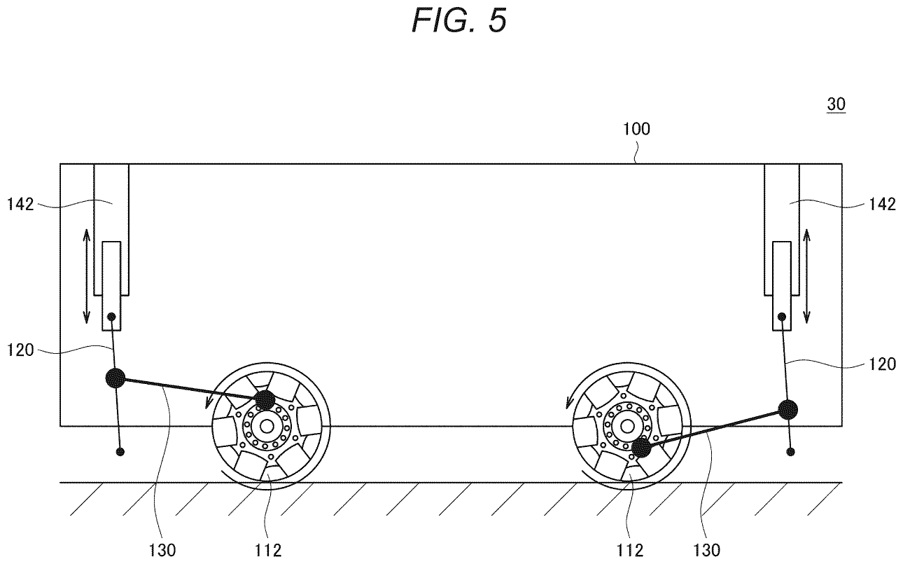

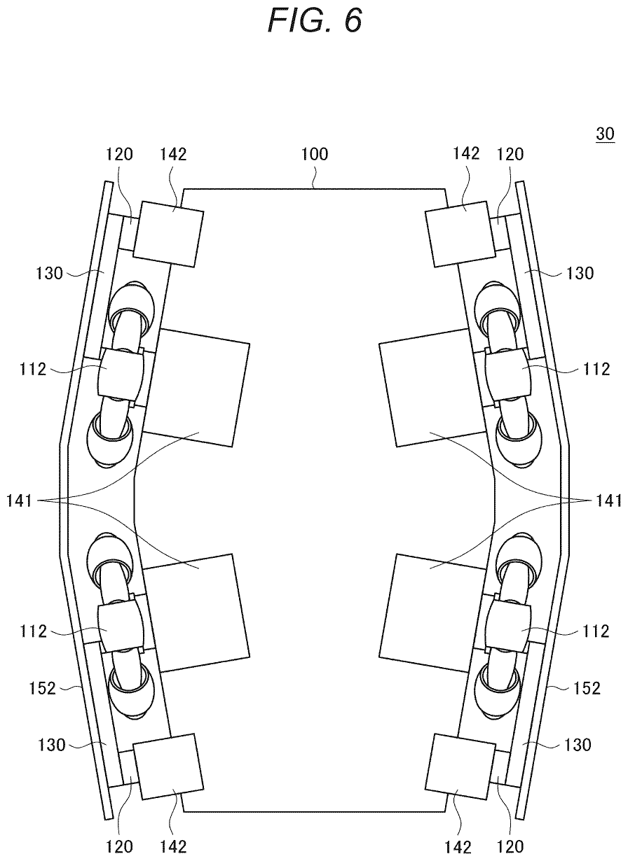

Subsequently, a third structure of the mobile body according to the present embodiment will be described with reference to FIGS. 5 and 6. FIG. 5 is a side view schematically illustrating a mobile body 30 according to the third structure. FIG. 6 is a schematic plan view illustrating a detailed structure of the mobile body 30 illustrated in FIG. 5.

As illustrated in FIG. 5, the mobile body 30 according to the third structure is different from the mobile body 10 according to the first structure in that a drive wheel 112 is an omni wheel. The omni wheel is a wheel that enables omnidirectional translation and configured by attaching a plurality of barrel-shaped rollers extending in the circumferential direction of the wheel side by side on the traveling surface in the circumferential direction.

In general, each of the omni wheels is attached to the main body part 100 such that rotation directions of the wheels are orthogonal to each other. However, in the mobile body 30, because the swinging direction of the leg part 120 is parallel to the attachment direction of the drive wheel 112, in a case where the swinging directions of the leg parts 120 are orthogonal to each other, leg walking by the leg part 120 becomes difficult. On the other hand, in a case where the drive wheels 112 are attached to the main body part 100 such that the rotation directions of the drive wheels 112 are parallel to each other, in the drive wheels 112, the orientations of the barrel-shaped rollers provided on the traveling surface of the wheels in the circumferential direction become parallel to each other. In such a case, because the mobile body 30 cannot apply force in the rotation shaft direction of the drive wheel 112, the movement in the rotation shaft direction by the rotation of the drive wheel 112 becomes difficult to be controlled.

In the mobile body 30, the drive wheel 112 is attached to the main body part 100 in an inclined manner at an angle of more than 0 degrees and less than 45 degrees, preferably at an angle of 10 degrees or more and 30 degrees or less with respect to the traveling direction of the mobile body 30. In such a case, because the mobile body 30 can align the swinging direction of the leg part 120 approximately parallel to the traveling direction of the mobile body 11, leg walking by the leg part 120 can be executed. Furthermore, in the mobile body 30, because the drive wheels 112 can be attached to the main body part 100 in a state of being inclined with respect to each other, force in the left-right direction orthogonal to the traveling direction of the mobile body 30 can be applied from the drive wheels 112. Therefore, the mobile body 30 can translate in the left-right direction orthogonal to the traveling direction of the mobile body 30 by the rotation of the drive wheels 112.

With this arrangement, for example, the mobile body 30 can pass through a narrow place where it is difficult to turn, by left-right movement without turning. Furthermore, at the time when an object or the like is being transported by an arm separately provided on the mobile body 30, the mobile body 30 can move left and right without greatly swinging the arm by turning. With this arrangement, because the mobile body 30 does not cause a change in the center of gravity due to swinging of the arm at the time of moving left and right orthogonal to the traveling direction, the object can be safely transported without losing balance.

Moreover, the drive wheel 112 can change distribution of speed and torque between the traveling direction of the mobile body 30 and the left-right direction orthogonal to the traveling direction by an attachment angle to the main body part 100. For example, by attaching the drive wheel 112 to the main body part 100 in an inclined manner at an angle of 10 degrees or more and 30 degrees or less with respect to the traveling direction, the mobile body 30 can perform wheel traveling with high torque and low speed in the traveling direction and can perform wheel traveling with low torque and high speed in the left-right direction.

More specifically, as illustrated in FIG. 6, the mobile body 30 includes one main body part 100 and four drive wheels 112. Each of the four drive wheels 112 is provided with the leg part 120, the motor 141, the leg part drive unit 142, and the transmission mechanism 130. Moreover, the mobile body 30 is provided with the exterior parts 152 on both sides in the left-right direction of the main body part 100.

As described above, the drive wheel 112 is an omni wheel, and is attached to the main body part 100 in an inclined manner at an angle of 10 degrees or more and 30 degrees or less with respect to the traveling direction of the mobile body 30. The leg part 120 is a longitudinal structural member, and is provided closer to an end side than the drive wheel 112 (that is, the outer side) in the traveling direction of the mobile body 30. The leg part 120 moves up and down in a direction perpendicular to the paper surface of FIG. 6 by the leg part drive unit 142, and swings with the rotational motion of the drive wheel 112.

The motor 141 is provided inside the housing of the main body part 100 correspondingly to the drive wheel 112, and rotates the drive wheel 112. The transmission mechanism 130 is a link that connects the drive wheel 110 to the leg part 120, and transmits the rotational motion of the drive wheel 112 into a reciprocating motion and transmits the reciprocating motion to the leg part 120. For example, the transmission mechanism 130 is a link that connects any one point in the radial direction of the drive wheel 110 and one point of the leg part 120.

The exterior part 152 is provided further on the outer side of the transmission mechanism 130 so as to cover the entire side surface of the mobile body 30. The exterior part 152 can protect the transmission mechanism 130, the drive wheel 112, and the leg part 120 from the external environment.

Hereinafter, a modification for eliminating or alleviating the influence of internal force on the leg part 120 and the like in a case where the drive wheel 112 is attached to the main body part 100 in an inclined manner will be described.

For example, in the mobile body 30 illustrated in FIG. 6, the swinging direction of the leg part 120 is fixed by the transmission mechanism 130 to cause the swinging direction to be parallel to the attachment direction of the drive wheel 112. Therefore, the leg part 120 is swung in an inclined manner with respect to the traveling direction of the mobile body 30. In such a case, because the mobile body 30 walks while swinging the main body part 100 left and right along the swinging direction of the leg part 120 at the time of leg walking, an internal force is generated inside the mobile body 30 at the time of kicking the ground, which may cause damage or the like.

In order to reduce the load due to the internal force in the left-right direction received by the mobile body 30 at the time when the leg part 120 is grounded, it is conceivable that the mobile body 30 is configured, for example, such that the leg part 120 is elastically deformable in the left-right direction orthogonal to the traveling direction of the mobile body 30.

Specifically, the leg part 120 may be provided by a member or a structure that is elastically deformable in the left-right direction orthogonal to the traveling direction of the mobile body 30. With this arrangement, the leg part 120 can absorb the internal force by the elastic deformation of the leg part 120, the internal force being generated in the left-right direction generated at the time when the leg part is grounded while the main body part 100 is swung left and right. Therefore, the mobile body 30 can reduce the load applied to the structure by the internal force in received by the leg part 120 at the time of grounding. Moreover, because the mobile body 30 can reduce the swinging of the main body part 100 in the left-right direction by bending the distal end of the leg part 120 at the time of grounding, collision, falling, or the like can be suppressed.

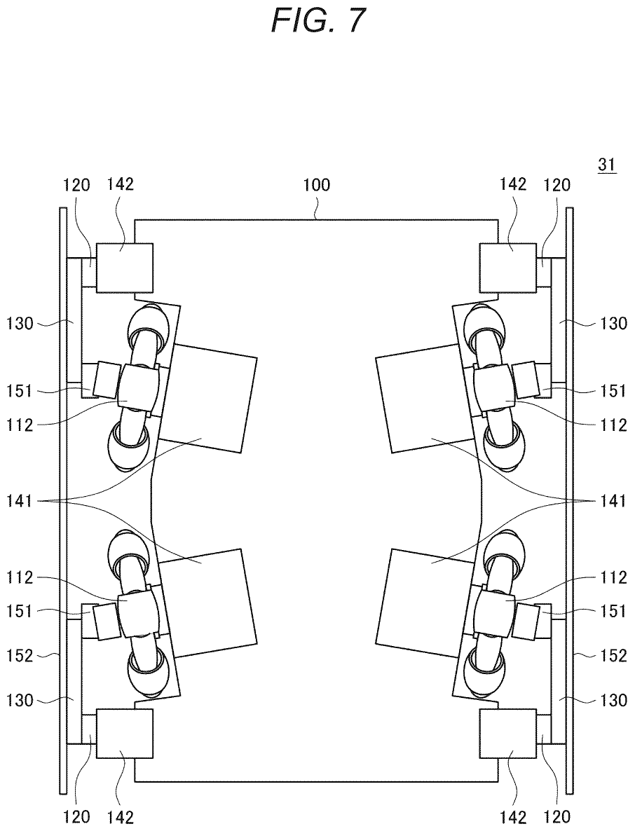

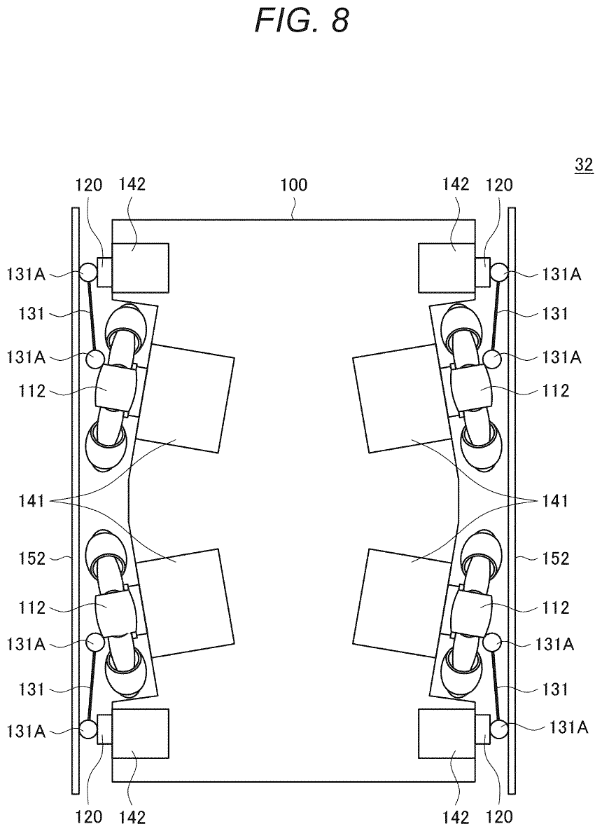

Moreover, with reference to FIGS. 7 and 8, a modification in which the influence of the internal force on the leg part 120 and the like is eliminated by adjusting the attachment angle of the drive wheel 112 and the attachment angle of the leg part 120 will be described. FIG. 7 is a schematic plan view of a modification in which the attachment angle between the drive wheel 112 and the leg part 120 is adjusted by using the universal joint 151. FIG. 8 is a schematic plan view of a modification in which the attachment angle between the drive wheel 112 and the leg part 120 is adjusted by using a ball joint 131A.

In the modification illustrated in FIG. 7, a mobile body 31 can control the attachment angle of the drive wheel 112 and the attachment angle of the leg part 120 with each other by connecting the drive wheel 112 and the leg part 120 by the universal joint 151.

The universal joint 151 is a mechanism that couples any one point in the radial direction of the drive wheel 112 (a point other than the center of the wheel) and the end of the transmission mechanism 130 at a free angle. By the transmission mechanism 130 being coupled to the drive wheel 112 at the universal joint 151, the reciprocating motion can be transmitted to the leg part 120 having the attachment angle different from the attachment angle of the leg part 120. With this arrangement, because the mobile body 30 can independently control the attachment angle of the drive wheel 112 and the attachment angle of the leg part 120, the orientation of the leg part 120 can be made parallel to the traveling direction of the mobile body 30. Therefore, because the mobile body 30 can prevent the main body part 100 from swinging left and right at the time of leg walking, the internal force can be prevented from being generated inside the mobile body 30 at the time when the leg part kicks the ground.

In the modification illustrated in FIG. 8, a mobile body 32 connects between the transmission mechanism 130, the drive wheel 112, and the leg part 120 with a ball joint 131A. With this arrangement, the transmission mechanism 130 can transmit the reciprocating motion from the drive wheel 112 to the leg part 120 regardless of the difference in attachment angle between the drive wheel 112 and leg part 120.

The ball joint 131A is a joint that is rotatable in any direction and includes a ball stud with a rod attached to a metal ball and a socket in spherical contact with the ball stud. Because the ball joint 131A is provided at both ends of the transmission mechanism 130, the transmission mechanism 130 and each of the drive wheel 112 and the leg part 120 can be rotatably coupled to each other.

With this arrangement, the transmission mechanism 130 can transmit the reciprocating motion from the drive wheel 112 to the leg part 120 regardless of the difference in attachment angle between the drive wheel 112 and leg part 120. Therefore, in the mobile body 32, the leg part 120 can be attached to the main body part 100 in parallel to the traveling direction of the mobile body 30. Therefore, because the mobile body 32 can prevent the main body part 100 from swinging left and right at the time of leg walking, the internal force can be prevented from being generated inside the mobile body 32 at the time when the leg part kicks the ground.

### 2. Modifications

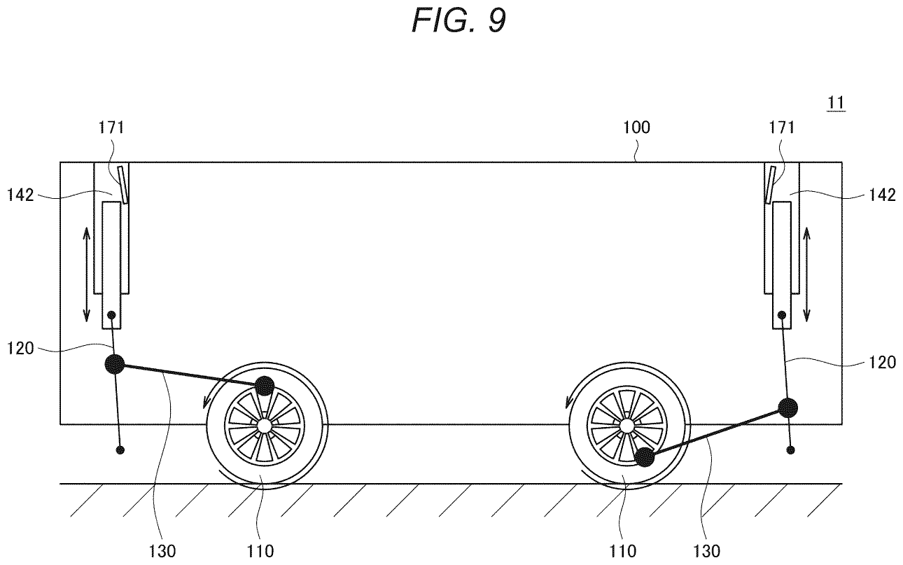

Next, modifications of the mobile body 10 according to the present embodiment will be described with reference to FIGS. 9 to 16. Hereinafter, the mobile body 10 according to the first structure will be mainly exemplified, but similar modifications can be applied to the mobile body 20 according to the second structure and the mobile body 30 according to the third structure.

### 2.1. First Modification

FIG. 9 is a side view schematically illustrating a structure of a mobile body 11 according to a first modification. As illustrated in FIG. 9, the mobile body 11 is different from the mobile body 10 illustrated in FIG. 1 in that a leg part holding unit 171 is further provided.

The leg part holding unit 171 is a mechanism that holds, by frictional force, the leg part 120 lifted in the upward direction by the leg part drive unit 142. For example, the leg part holding unit 171 may be a friction plate provided obliquely in the upward direction of the leg part drive unit 142. The leg part holding unit 171 is pressed by a spring or the like against the leg part drive unit 142 lifted in the upward direction to apply force to the leg part drive unit 142 and the leg part 120 to enable the leg part 120 to be prevented from falling due to gravity or inertia.

With this arrangement, the leg part holding unit 171 can hold the leg part 120 lifted by the leg part drive unit 142 in the upward direction by frictional force without using electric power. Therefore, in the mobile body 11, because the leg part holding unit 171 can prevent the leg part 120 from falling due to its own weight at the time of wheel traveling without consuming power, power consumption at the time of wheel traveling can be reduced. Therefore, the mobile body 11 can perform wheel traveling by more efficiently using energy.

Note that, in a case where the leg walking is performed, the leg part drive unit 142 can cause the leg part 120 to be pushed downward and grounded by causing a force equal to or greater than the frictional force by the leg part holding unit 171 to act on the leg part 120. That is, the gravity due to the own weight of the leg part 120, the frictional force by the leg part holding unit 171, and the driving force by the leg part drive unit 142 are set to have the following relationship.

Gravity to leg part 120<Frictional force by leg part holding unit 171<Driving force by leg part drive unit 142

### 2.2. Second Modification

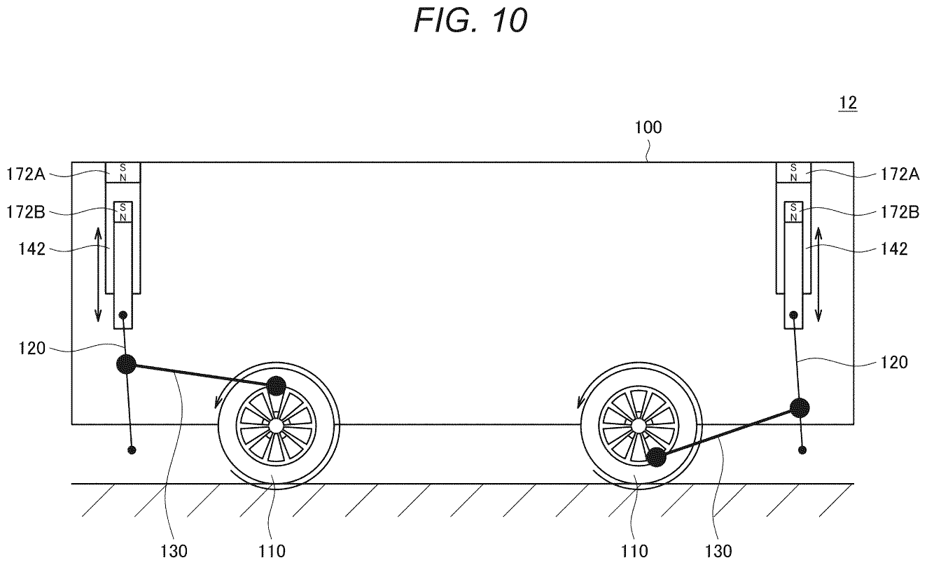

FIG. 10 is a side view schematically illustrating a structure of a mobile body 12 according to a second modification. As illustrated in FIG. 10, the mobile body 12 is different from the mobile body 10 illustrated in FIG. 1 in that a first leg part holding unit 172A and a second leg part holding unit 172B are further provided.

The first leg part holding unit 172A and the second leg part holding unit 172B are each a mechanism that holds, by magnetic force, the leg part 120 lifted in the upward direction by the leg part drive unit 142. For example, the first leg part holding unit 172A may be a permanent magnet provided with a first magnetic pole (one of the S pole and the N pole) facing the leg part drive unit 142 further in the upward direction of the leg part drive unit 142. The second leg part holding unit 172B may be a permanent magnet provided with a second magnetic pole (the other of the S pole and the N pole) at the upper portion of the leg part drive unit 142 in a manner of facing the first leg part holding unit 172A. The first leg part holding unit 172A generates an attractive force caused by the magnetic field with the second leg part holding unit 172B to apply a force to the leg part drive unit 142 and the leg part 120, which can prevent the leg part 120 from falling due to gravity or inertia.

With this arrangement, the first leg part holding unit 172A and the second leg part holding unit 172B can hold the leg part 120 lifted by the leg part drive unit 142 by magnetic force in the upward direction without using electric power. Therefore, in the mobile body 12, because the first leg part holding unit 172A and the second leg part holding unit 172B can prevent the leg part 120 from falling due to its own weight at the time of wheel traveling without consuming power, power consumption at the time of wheel traveling can be reduced. Therefore, the mobile body 12 can perform wheel traveling by more efficiently using energy.

Note that, in a case where the leg walking is performed, the leg part drive unit 142 can cause the leg part 120 to be pushed downward and grounded by causing a force equal to or greater than the attractive force by the first leg part holding unit 172A and the second leg part holding unit 172B to act on the leg part 120. That is, the gravity due to the own weight of the leg part 120, the attractive force by the magnetic field of the first leg part holding unit 172A and the second leg part holding unit 172B, and the driving force by the leg part drive unit 142 are set to have the following relationship.

Gravity to leg part 120<Attractive force by magnetic field<Driving force by leg part drive unit 142

### 2.3. Third Modification

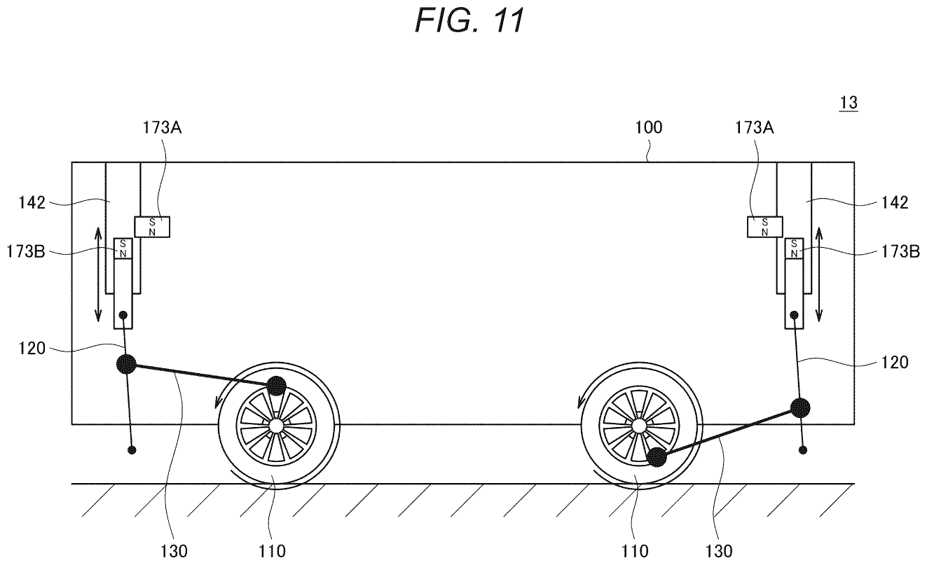

FIG. 11 is a side view schematically illustrating a structure of a mobile body 13 according to a third modification. As illustrated in FIG. 11, the mobile body 13 is different from the mobile body 10 illustrated in FIG. 1 in that a first leg part holding unit 173A and a second leg part holding unit 173B are further provided.

The first leg part holding unit 173A and the second leg part holding unit 173B are each a mechanism that holds, by magnetic force, the leg part 120 lifted in the upward direction by the leg part drive unit 142. For example, the first leg part holding unit 173A may be a permanent magnet provided on the side of the leg part drive unit 142 in a state where a first magnetic pole (one of the S pole and the N pole) is arranged on the upper side and a second magnetic pole (the other of the S pole and the N pole) is arranged on the lower side. The second leg part holding unit 173B may be a permanent magnet provided in the upper portion of the leg part drive unit 142 in a state where the second magnetic pole (the other of the S pole and the N pole) is arranged on the upper side and the first magnetic pole (one of the S pole and the N pole) is arranged on the lower side. The first leg part holding unit 173A generates a repulsive force between the first magnetic poles with the second leg part holding unit 173B lifted further upward than the first leg part holding unit 173A to apply a force to the leg part drive unit 142 and the leg part 120, which can prevent the leg part 120 from falling due to gravity or inertia.

With this arrangement, the first leg part holding unit 173A and the second leg part holding unit 173B can hold the leg part 120 lifted by the leg part drive unit 142 in the upward direction by magnetic force without using electric power. Therefore, in the mobile body 13, because the first leg part holding unit 173A and the second leg part holding unit 173B can prevent the leg part 120 from falling due to its own weight at the time of wheel traveling without consuming power, power consumption at the time of wheel traveling can be reduced. Therefore, the mobile body 13 can perform wheel traveling by more efficiently using energy.

Note that, in a case where the leg part 120 is to be pushed out in the downward direction in order to perform leg walking, the second leg part holding unit 173B sequentially transitions from a state of being present in the upward direction with respect to the first leg part holding unit 173A, to a state of being substantially parallel to the first leg part holding unit 173A, and to a state of being present in the downward direction with respect to the first leg part holding unit 173A. At this time, the second leg part holding unit 173B sequentially transitions from a state in which the repulsive force between the first magnetic poles acts with the first leg part holding unit 173A, to a state in which the attractive force between the first magnetic pole and the second magnetic pole acts therewith, and to a state in which the repulsive force between the second magnetic poles acts therewith.

With this arrangement, the second leg part holding unit 173B can receive the repulsive force in the downward direction from the first leg part holding unit 173A by being present in the downward direction with respect to the first leg part holding unit 173A. Therefore, because the first leg part holding unit 173A and the second leg part holding unit 173B can urge the movement of pushing the leg part 120 in the downward direction, the mobile body 13 can more easily perform motion such as a jump in which the leg part 120 steps on the ground more strongly.

### 2.4. Fourth Modification

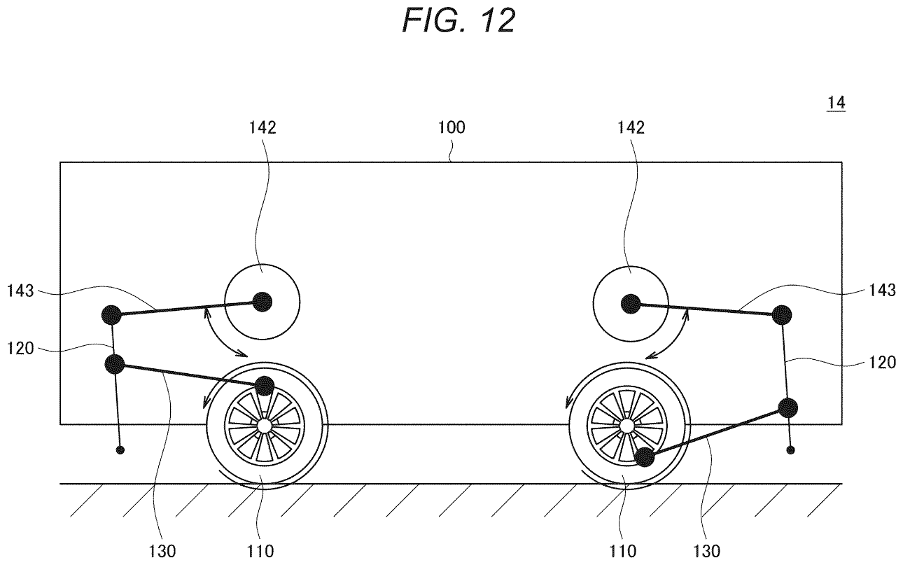

FIG. 12 is a side view schematically illustrating a structure of a mobile body 14 according to a fourth modification. As illustrated in FIG. 12, the mobile body 14 is different from the mobile body 10 illustrated in FIG. 1 in that the leg part drive unit 142 includes a rotary motor, and the leg part 120 is driven in the up-down direction via a link mechanism 143.

Specifically, in the mobile body 14 according to the fourth modification, the leg part drive unit 142 is a rotary motor that performs rotational motion by consuming electric power. The link mechanism 143 is a driving force transmission mechanism that converts the rotational motion of the leg part drive unit 142 that is a rotary motor into a reciprocating motion in the up-down direction and transmits the reciprocating motion to the leg part 120. The link mechanism 143 can cause one end of the link connected to the leg part 120 to perform reciprocating motion in the up-down direction by one end of the link connected to the leg part drive unit 142 rotating along with the rotation of the leg part drive unit 142 that is a rotary motor.

With this arrangement, because the mobile body 14 can drive the leg part 120 in the up-down direction with a less expensive structure, the manufacturing cost can be reduced. Furthermore, in the mobile body 14, the leg part 120 can be driven in the up-down direction by the rotary motor and the link mechanism 143 which are more compact than a trapezoidal screw, a ball screw, a shaft motor, an ultrasonic actuator, a pneumatic cylinder, a water pressure cylinder, or an oil pressure cylinder extending in the up-down direction, and thus, the vehicle body height and the center of gravity can be further lowered.

### 2.5. Fifth Modification

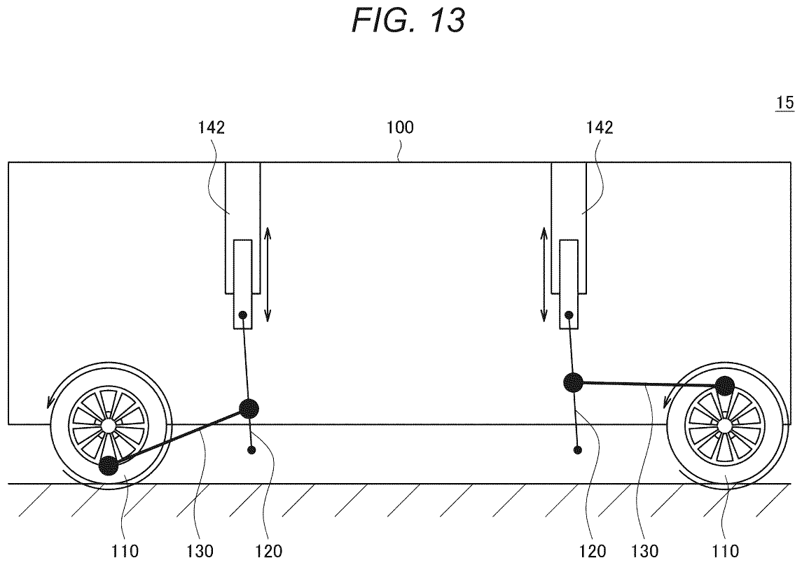

FIG. 13 is a side view schematically illustrating a structure of a mobile body 15 according to a fifth modification. As illustrated in FIG. 13, the mobile body 15 is different from the mobile body 10 illustrated in FIG. 1 in that positions of the leg part 120 and the leg part drive unit 142, and the drive wheel 110 are reversed.

Specifically, in the mobile body 15 according to the fifth modification, the drive wheel 110 is provided closer to the end side (that is, the outer side in the front-rear direction) of the mobile body 10 than the leg part 120 in the traveling direction of the mobile body 10. For example, the drive wheels 110 may be provided at positions corresponding to four corners of the bottom surface of the main body part 100. The leg parts 120 may be provided at positions corresponding to the central side surface of the main body part 100.

With this arrangement, because the mobile body 15 can further increase the area of the support polygon connecting the grounding points of the drive wheels 110, the stability at the time of wheel traveling can be further improved.

### 2.6. Sixth Modification

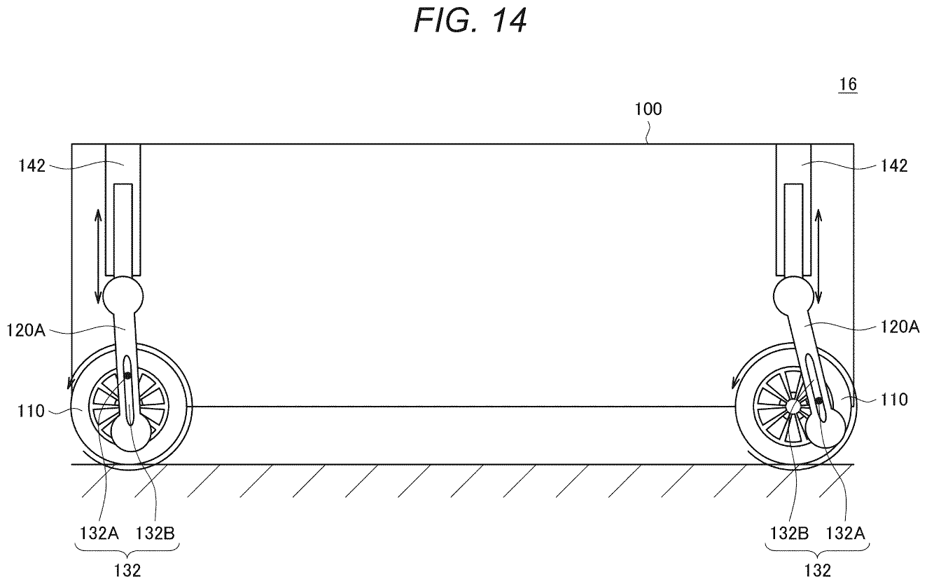

FIG. 14 is a side view schematically illustrating a structure of a mobile body 16 according to a sixth modification. As illustrated in FIG. 14, the mobile body 16 according to the sixth modification is different from the mobile body 10 illustrated in FIG. 1 in that a leg part 120A and the leg part drive unit 142, and the drive wheel 110 are provided substantially at the same position.

Specifically, in the mobile body 16 according to the sixth modification, the leg part 120A is provided on the side surface of drive wheel 110. A transmission mechanism 132 is provided between the leg part 120A and the drive wheel 110, the transmission mechanism 132 converting the rotational motion of the drive wheel 110 into a reciprocating motion and transmits the reciprocating motion to the leg part 120.

The transmission mechanism 132 includes a post 132A provided on the side surface of the drive wheel 110 and a sliding groove 132B provided in the leg part 120A and engaging the post 132A with the sliding groove 132B. By revolving about the rotation shaft of the drive wheel 110 along with the rotation of the drive wheel 110, the post 132A slides in the sliding groove 132B engaged therewith in the up-down direction to enable the leg part 120A to be swung in the front-rear direction. With this arrangement, the transmission mechanism 132 can convert the rotational motion of the drive wheel 110 into a reciprocating motion and transmits the reciprocating motion to the leg part 120A.

With this arrangement, because the mobile body 16 can further increase both the area of the support polygon connecting the grounding points of the drive wheels 110 and the area of the support polygon connecting the grounding points of the leg parts 120A, the stability at the time of both wheel traveling and leg walking can be further improved. Furthermore, because the free space in the central portion of the main body part 100 can be further increased, the mobile body 16 can transport more objects at the time of transporting the objects.

### 2.7. Seventh Modification

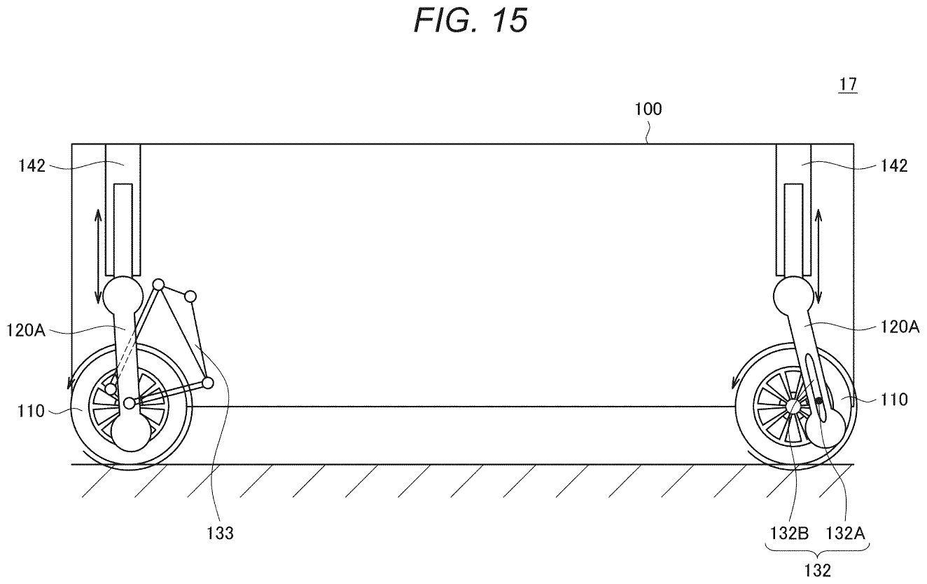

FIG. 15 is a side view schematically illustrating a structure of a mobile body 17 according to a seventh modification. As illustrated in FIG. 15, the mobile body 17 according to the seventh modification is different from the mobile body 16 illustrated in FIG. 14 in that a part of the leg parts 120A and the drive wheels 110 are connected by a transmission mechanism 133 including a link mechanism.

Specifically, in the mobile body 17 according to the seventh modification, the leg part 120A is provided on the side surface of drive wheel 110 to be provided substantially at the same position as the drive wheel 110. By using the link mechanism, the transmission mechanism 133 converts the rotational motion of the drive wheel 110 into a reciprocating motion that moves a distance longer than the diameter of the drive wheel 110, and transmits the reciprocating motion to the leg part 120A. The distance of the reciprocating motion by the transmission mechanism 133 can be controlled by, for example, the structure of the link mechanism constituting the transmission mechanism 133.

With this arrangement, in the mobile body 17, because the stroke width of the swing of the leg part 120A can be made longer than the diameter of the drive wheel 110, the climbing ability on the step or the like at the time of leg walking can be further improved.

### 2.8. Eighth Modification

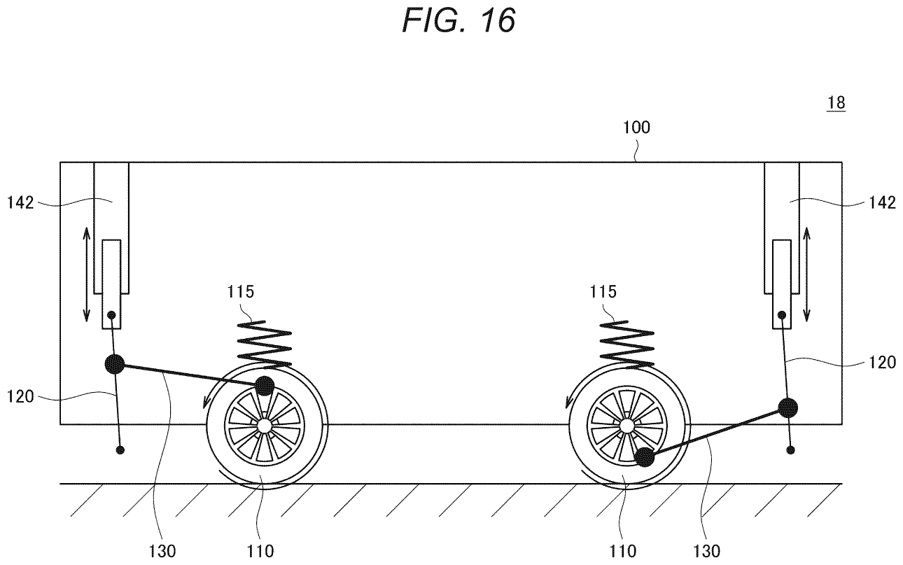

FIG. 16 is a side view schematically illustrating a structure of a mobile body 18 according to an eighth modification. As illustrated in FIG. 16, the mobile body 18 according to the eighth modification is different from the mobile body 10 illustrated in FIG. 1 in that a suspension 115 is provided in the drive wheel 110.

The suspension 115 is a mechanism for attaching the drive wheel 110 to the main body part 100 while interposing a spring and a shock absorber. The suspension 115 can make the drive wheel 110 be grounded more satisfactory by moving the drive wheel 110 up and down with respect to the unevenness of the ground. Furthermore, by buffering and attenuating the vibration transmitted from the ground to the drive wheel 110 with the spring and the shock absorber, the suspension 115 can suppress the vibration from the ground from being transmitted to the main body part 100.

With this arrangement, in the mobile body 18, each of the drive wheels 110 can be grounded more reliably by the suspension 115 at the time of wheel traveling. On the other hand, because the suspension 115 does not act on the leg part 120 provided independently of the drive wheel 110, the mobile body 18 can prevent the impact of the leg part 120 at the time of grounding from being amplified by the spring of the suspension 115 at the time of leg walking. Therefore, the mobile body 18 can move while being reliably grounded at the time of both wheel traveling and leg walking.

### 3. Supplementary Note

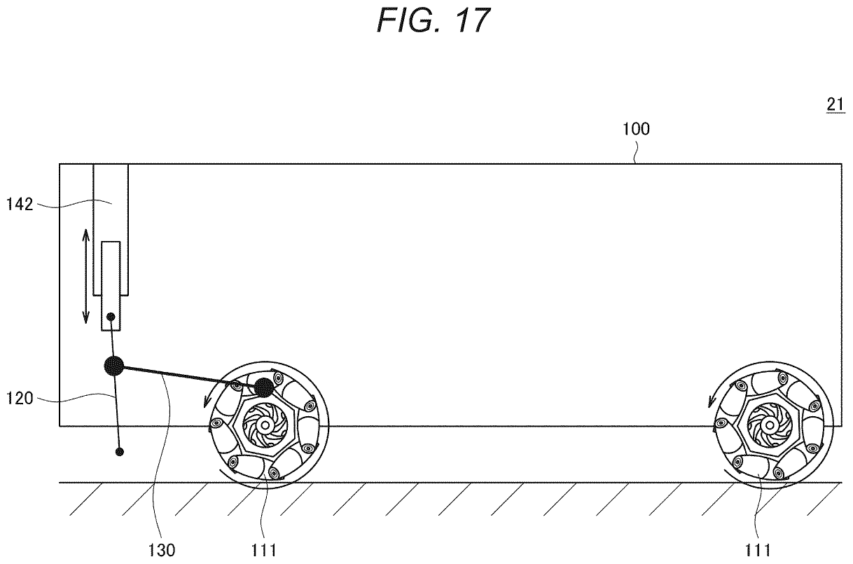

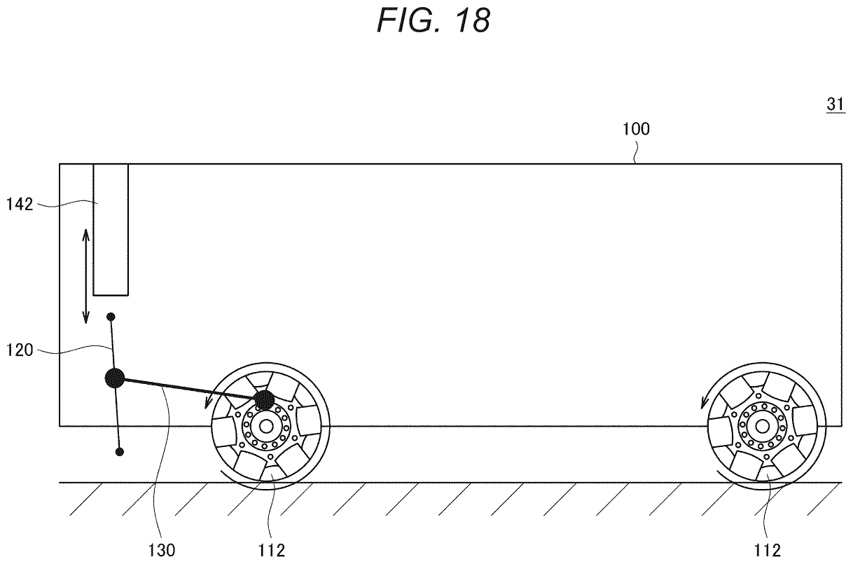

The mobile bodies 10, 20, and 30 according to the present embodiment have been described in detail above. However, in the mobile bodies 10, 20, and 30 according to the present embodiment, the leg parts 120 may be provided in all of the four drive wheels 110, or the leg parts 120 may be provided in a part of the four drive wheels 110. Such a point will be described with reference to FIGS. 17 and 18.

FIG. 17 is a side view schematically illustrating a structure of a mobile body 21 including four drive wheels 111 of mecanum wheels and the leg parts 120 in only two front wheels. The mobile body 21 illustrated in FIG. 17 can perform omnidirectional wheel traveling by controlling the rotation direction and the rotation speed of the drive wheels 111 of the mecanum wheels. Furthermore, the mobile body 21 can perform an auxiliary motion of climbing a step with the leg parts 120 of the two front wheels at the time of wheel traveling on the uneven ground.

FIG. 18 is a side view schematically illustrating a structure of a mobile body 31 including four drive wheels 112 of omni wheels and the leg parts 120 in only two front wheels. The mobile body 31 illustrated in FIG. 18 can perform omnidirectional wheel traveling by controlling the rotation direction and the rotation speed of the drive wheels 112 of the omni wheels. Furthermore, the mobile body 31 can perform an auxiliary motion of climbing a step with the leg parts 120 of the two front wheels at the time of wheel traveling on the uneven ground.

Furthermore, in the mobile body 10 according to the present embodiment, one of the two front wheels or the two rear wheels can be the drive wheels 110, and the other of the two front wheels or the two rear wheels can be driven wheels, so that the number of motors to be mounted can be reduced. With this arrangement, the mobile body 10 according to the present embodiment can further reduce the manufacturing cost. Moreover, the mobile body 10 according to the present embodiment can further improve the turning performance by providing the leg parts 120 only on the drive wheels 110 of the two front wheels and using the two rear wheels as the omni wheels.

While the preferred embodiment of the present disclosure has been described in detail with reference to the accompanying drawings, the technical scope of the present disclosure is not limited to such examples. It is obvious that those with ordinary skill in the technical field of the present disclosure can conceive various alterations or corrections within the scope of the technical idea recited in the claims, and it is naturally understood that those alterations or corrections also fall within the technical scope of the present disclosure.

Because the mobile body to which the technology according to the present disclosure has good energy efficiency at the time of wheel traveling and can provide a large free space in the main body part 100, the mobile body is suitable for a transportation purpose of transporting an article, a medical or nursing care purpose of transporting a person, a following purpose of following the movement of a person, an environmental map creation purpose, an inspection purpose of checking or investigating the environment, or the like. The mobile body to which the technology according to the present disclosure is applied can be used for applications in the EdTech (Education+Technology) field, the entertainment field, or the research and development field, or the like.

Furthermore, the effects described in the present description are merely exemplary or illustrative, and are not restrictive. In other words, the technology according to the present disclosure may exhibit other effects apparent to those skilled in the art from the description of the present description, in addition to the effects described above or instead of the effects described above.

Note that the following configurations also fall within the technological scope of the present disclosure.
(1)

A mobile body including:
a main body part;
at least one or more drive wheels attached to the main body part and rotated by driving of a motor;
a leg part provided correspondingly to each of the drive wheels and moving forward and backward in accordance with rotation of the drive wheel; and
a leg part drive unit that controls driving of the leg part in an up-down direction.
(2)

The mobile body according to (1) described above, in which the drive wheel is an omnidirectional wheel.
(3)

The mobile body according to (2) described above, in which the omnidirectional wheel is a mecanum wheel.
(4)

The mobile body according to (2) described above, in which the omnidirectional wheel is an omni wheel.
(5)

The mobile body according to (4) described above, in which the omni wheel is attached to the main body part in an inclined manner at an angle of more than 0 degrees and less than 45 degrees with respect to a traveling direction of the mobile body.
(6)

The mobile body according to (5) described above, in which the leg part is provided in parallel to the traveling direction.
(7)

The mobile body according to (5) described above, in which the leg part is formed elastically deformable in a direction orthogonal to the traveling direction, and provided in an inclined manner with respect to the traveling direction.
(8)

The mobile body according to any one of (1) to (7) described above, further including a leg part holding unit that holds a position of the leg part driven in an upward direction in the upward direction.
(9)

The mobile body according to (8) described above, in which the leg part holding unit holds the position of the leg part by using frictional force.
(10)

The mobile body according to (8) described above, in which the leg part holding unit holds the position of the leg part by using attractive force of a magnetic field.
(11)

The mobile body according to (8) described, in which the leg part holding unit holds the position of the leg part by using repulsive force of a magnetic field.
(12)

The mobile body according to any one of (1) to (11) described above, in which the leg part drive unit includes a trapezoidal screw, a ball screw, a shaft motor, an ultrasonic actuator, a pneumatic cylinder, a water pressure cylinder, or an oil pressure cylinder.
(13)

The mobile body according to any one of (1) to (7) described above, in which
the leg part drive unit is a rotary motor, and
the rotary motor has a rotational force that is converted into driving force in the up-down direction by a link mechanism.
(14)

The mobile body according to any one of (1) to (13) described above, in which the drive wheel is attached to the main body part while interposing a suspension between the drive wheel and the main body part.
(15)

The mobile body according to any one of (1) to (14) described above, in which the drive wheel is provided closer on an end side of the mobile body than the leg part in a traveling direction of the mobile body.
(16)

The mobile body according to any one of (1) to (14) described above, in which the drive wheel is provided at a position overlapping the leg part in a traveling direction of the mobile body.
(17)

The mobile body according to any one of (1) to (16) described above, in which the drive wheel is included in at least two front wheels or two rear wheels of the mobile body in a traveling direction.
(18)

The mobile body according to (17) described above, in which one of the two front wheels or the two rear wheels are the drive wheels that can move in one direction, and another of the two front wheels or the two rear wheels are omni wheels.
(19)

The mobile body according to any one of (1) to (16) described above, in which
the main body part is attached with four pieces of the drive wheels, and
the leg part is provided correspondingly to each of the four pieces of the drive wheels.

### REFERENCE SIGNS LIST

10, 20, 30 Mobile body
100 Main body part
110, 111, 112 Drive wheel
120 Leg part
130 Transmission mechanism
131A Ball joint
141 Motor
142 Leg part drive unit
151 Universal joint
152 Exterior part
171 Leg part holding unit
172A, 173A First leg part holding unit
173A, 173B Second leg part holding unit

1. A mobile body comprising:
a main body part;
at least one or more drive wheels attached to the main body part and rotated by driving of a motor;
a leg part provided correspondingly to each of the drive wheels and moving forward and backward in accordance with rotation of the drive wheel; and
a leg part drive unit that controls driving of the leg part in an up-down direction.

2. The mobile body according to claim 1, wherein the drive wheel is an omnidirectional wheel.

3. The mobile body according to claim 2, wherein the omnidirectional wheel is a mecanum wheel.

4. The mobile body according to claim 2, wherein the omnidirectional wheel is an omni wheel.

5. The mobile body according to claim 4, wherein the omni wheel is attached to the main body part in an inclined manner at an angle of more than 0 degrees and less than 45 degrees with respect to a traveling direction of the mobile body.

6. The mobile body according to claim 5, wherein the leg part is provided in parallel to the traveling direction.

7. The mobile body according to claim 5, wherein the leg part is formed elastically deformable in a direction orthogonal to the traveling direction, and provided in an inclined manner with respect to the traveling direction.

8. The mobile body according to claim 1, further comprising a leg part holding unit that holds a position of the leg part driven in an upward direction in the upward direction.

9. The mobile body according to claim 8, wherein the leg part holding unit holds the position of the leg part by using frictional force.

10. The mobile body according to claim 8, wherein the leg part holding unit holds the position of the leg part by using attractive force of a magnetic field.

11. The mobile body according to claim 8, wherein the leg part holding unit holds the position of the leg part by using repulsive force of a magnetic field.

12. The mobile body according to claim 1, wherein the leg part drive unit includes a trapezoidal screw, a ball screw, a shaft motor, an ultrasonic actuator, a pneumatic cylinder, a water pressure cylinder, or an oil pressure cylinder.

13. The mobile body according to claim 1, wherein
the leg part drive unit is a rotary motor, and
the rotary motor has a rotational force that is converted into driving force in the up-down direction by a link mechanism.

14. The mobile body according to claim 1, wherein the drive wheel is attached to the main body part while interposing a suspension between the drive wheel and the main body part.

15. The mobile body according to claim 1, wherein the drive wheel is provided closer on an end side of the mobile body than the leg part in a traveling direction of the mobile body.

16. The mobile body according to claim 1, wherein the drive wheel is provided at a position overlapping the leg part in a traveling direction of the mobile body.

17. The mobile body according to claim 1, wherein the drive wheel is included in at least two front wheels or two rear wheels of the mobile body in a traveling direction.

18. The mobile body according to claim 17, wherein one of the two front wheels or the two rear wheels are the drive wheels that can move in one direction, and another of the two front wheels or the two rear wheels are omni wheels.

19. The mobile body according to claim 1, wherein
the main body part is attached with four pieces of the drive wheels, and
the leg part is provided correspondingly to each of the four pieces of the drive wheels.
